(19) United States
(12) Patent Application Publication
(10) Pub. No.: US 2004/0082803 A1
(43) Pub. Date: Apr. 29, 2004

(54) Trichlorosilyl groups containing organochlorosilanes and their preparation methods by the double-silylation of olefins with trichlorosilane

(75) Inventors: Il Nam Jung, Yongin-shi (KR); Bok Ryul Yoo, Kyunggi-do (KR); Joon Soo Han, Sungnam-shi (KR); Seung-Hyun Kang, Seoul (KR)

Correspondence Address: Finnegan, Henderson, Farabow,, Garrett & Dunner, L.L.P., 1300 I Street, N.W., Washington, DC, 20005-3315, US

(73) Assignee: KOREA INSTITUTE OF SCIENCE AND TECHNOLOGY

(21) Appl. No.: 10/400,875

(22) Filed: Mar. 28, 2003

(30) Foreign Application Priority Data
May 7, 2002 (KR) 10-2002-0025016

(51) Int. Cl. C07F 7/04

(52) U.S. Cl. 556/484

(57) ABSTRACT

The present invention provides organosilicon compounds containing two trichlorosilyl groups and their preparation methods. Organosilicon compounds of formula II are prepared by reacting linear chain or cyclic olefins of formula I with trichlorosilane in the presence of quaternary organophosphonium salt as a catalyst.

R¹—HC═CH—R² (I)

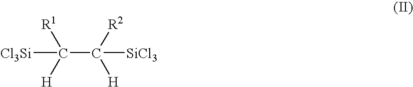

In formulas I and II, R¹ and R² may be identical or different and represent a hydrogen atom, a linear or a cyclic C₁-C₈ alkyl, a linear or a cyclic C₁-C₈ alkenyl, benzyl, phenyl, a C₁-C₈ alkyl substituted phenyl group, two functional groups between R¹ and R² may be covalently bonded to form a C₄-C₈ ring with or without a carbon-carbon double bond.

### BACKGROUND OF THE INVENTION

1. Field of the Invention

The present invention relates to organosilicon compounds containing two trichlorosilyl groups and their preparation methods. More particularly, the present invention relates to organosilicon compounds of formula II and their preparation methods by reacting linear chain or cyclic olefins of formula I with trichlorosilane in the presence of quaternary organophosphonium salt as a catalyst.

R¹—HC═CH—R² (I)

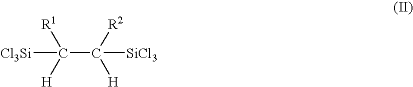

In formulas I and II, R¹ and R² may be identical or different and represent a hydrogen atom, a linear or a cyclic C₁-C₈ alkyl, a linear or a cyclic C₁-C₈ alkenyl, benzyl, phenyl, a C₁-C₈ alkyl substituted phenyl group, two functional groups between R¹ and R² may be covalently bonded to form a C₄-C₈ ring with or without a carbon-carbon double bond.

2. Description of the Prior Art

In 1965, Benkeser and co-workers reported the hydrosilylation of phenylacetylene with excess trichlorosilane in the presence of tributylamine catalyst to give 1,2-bis(trichlorosilyl)ethylbenzene in 38% yield [Benkeser, R. A.; Dunny, S. J. Organometal. Chem., 1965, 4, 338-340].

In 1969, Gerval and co-workers also reported a double silylation of styrene using trimethylchlorosilane and magnesium metal to give 1,2-bis(trimethylsilyl)styrenes, however, this method cannot be applied to the preparation of functional silanes. [Jacqueline, Gerval, J. Organometal. Chem., 1969, 20, 20-21]. Although Kumada and co-workers reported double silylation reactions of various acetylenes and conjugated dienes with disilanes in the presence of palladium complexes in the middle of seventies, the disilanes are not easy to prepare and are rather expensive chemicals [Makoda Kumada et al, J. Organometal. Chem., 1975, 86, C₂₇-C₃₀, J. Organonmetal. Chem. 1976, 114, C₁₉-C₂₁].

In 1982, Nagai et al also reported an addition of disilanes to allenic compounds in the presence of phosphine complexes [Yoichiro Nagai et al, J. Organometal. Chem. 1982, 225, 343-356]. Recently Tanaka and co-workers reported dehydrogenative double silylation of olefins with ortho-bis(dimethylsilyl)benzene in the presence of platinum phosphine complex [Masato Tanaka et al, J. Organometal. Chem. 1992, 428, 1-12, Tamejiro Hiyama et al, Tetrahedron Lett. 1987, 28, 1807-1810, Takashi Kawamura et al, Orgnomeallics 1993, 12, 2853-2856, Noboru Sonoda, Tetrahedron Lett. 1998, 39, 9697-9698].

In the previous reports, the double silylation reactions required expensive disilanes. Since disilanes are not readily available, it would be too costly to utilize the methods on a large scale in industry. It is necessary to find a way to find cheap and readily available silanes to substitute disilanes and to find an effective catalyst to apply the double silylation for industrial purposes.

The present inventors have discovered that a coupling reaction of alkyl chloride and hydrochlorosilanes in the presence of quaternary phosphonium salts as a catalyst proceeded to give the corresponding coupled products by liberating hydrogen halide as a gas. [I. N. Jung et al, U.S. Pat. No. 6,392,077]. During this investigation, it was found that the coupling reaction of allyl halides such as allyl chloride or methylallyl chloride with trichlorosilane gave allyltrichlorosilanes as the major products along with a small amount of 1,2,3-tris(trichlorosilyl)propanes as minor products. After optimizing the reaction conditions, it was also found that the double silylation reaction was proceeded at a little higher temperature around 180° C. than that of the coupling reaction.

The double silylation reactions of the present invention required readily available trichlorosilane and are more economically feasible compared with the previous reports requiring expensive disilanes.

### SUMMARY OF THE INVENTION

The present invention relates to organosilicon compounds containing two trichlorosilyl groups and their preparation methods. More particularly, the present invention relates to organosilicon compounds of formula II and their preparation methods by reacting linear chain or cyclic olefins of formula I with trichlorosilane in the presence of quaternary organophosphonium salt as a catalyst.

R¹—HC═CH—R² (I)

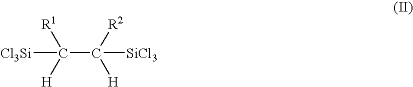

In formulas I and II, R¹ and R² may be identical or different and represent a hydrogen atom, a linear or cyclic C₁-C₈ alkyl, a linear or a cyclic C₁-C₈ alkenyl, benzyl, phenyl, a C₁-C₈ alkyl substituted phenyl group, two functional groups between R1 and R2 may be covalently bonded to form a C₄-C₈ ring with or without a carbon-carbon double bond.

The present invention is described in detail as set forth hereunder.

The double silylation reaction of olefins represented by formula I with trichlorosilane in the present invention can be carried out in most organic solvents such as toluene, hexane, tetrahydrofuran, or acetonitrile, but it also proceeds in a neat condition. After sealing the reaction tube with a stainless steel stopper, heating and stirring may be carried out for a predetermined period of time, generally for about from 1 hour to about 48 hours, to complete the reaction. The reaction is carried out at a temperature from 10° C. to 250° C., but the preferred reaction temperature range is from 130° C. to 200° C.

In a typical preparation, olefins of formula I, quaternary phosphonium salt catalyst, and trichlorosilane are placed all together in a sealed stainless steel tube under inert atmosphere. The amount of trichlorosilane is two equivalents or more, preferably 3 to 5 folds, relative to the amount of olefin represented by formula I. Quaternary phosphonium is used as a catalyst in an amount sufficient to catalyze the reaction, generally, 1 to 100 mol %, preferably 3 to 15%, relative to the mole of the compound of formula I.

After completion of the reaction, hydrocarbon solvents such as hexane are added to the product mixture to precipitate out the catalyst. The catalyst is filtered and recovered up to 80% for recycling. The products are distilled under atmospheric pressure or a vacuum.

The olefins represented by formula I used in this invention can be selected from the group consisting of 1-hexene, styrene, 4-methylstyrene, allylbenzene, 4-vinyl-1-cyclohexene, trans-stybene, 1-pentene, 1-decene, cyclopentene, cyclohexene, cyclohexadiene, norbonylene, and divinylbenzene.

The catalyst of quaternary phosphonium salt may be represented by the following formula III,

X(R⁴)₄P (III)

wherein X is chloro, bromo, iodo; and R⁴ can be covalently bonded to form a C₄-C₈ ring with or without carbon-carbon double bond and each R⁴ is independently selected from a V₁₋₁₂ alkyl, C₁₋₆ alkyl substituted aromatics or phenyl groups.

The catalyst can also be represented by the following formula IV,

X(R⁴)₃P—Y—P(R⁴)₃X (IV)

wherein X is chloro, bromo, iodo; Y is selected from a C₁-C₁₂ alkyl or an alkenyl and optionally alkyl substituted aromatic; and R⁴ can be covalently bonded to form a C₁-C₁₂ alkyl, a ring with or without a carbon-carbon double bond and each R⁴ is independently selected from a C₁₋₁₂ alkyl, C₁₋₆ alkyl substituted aromatics or phenyl groups.

The above catalysts can be used in an immobilized form on a silicone resin, silica, inorganic supporter, or organic polymer [I. N. Jung et al, U.S. Pat. No. 6,392,077].

The catalysts represented by formulas III and IV used in this invention may be benzyltributylphosphonium chloride, tetrabutylphosphonium chloride, tetrabutylphosphonium bromide, tetrabutylphosphonium iodide, tetramethylphosphonium chloride, tetraethylphosphonium chloride, benzyltriphenylphosphonium chloride, ethylene bis(benzyldimethylphosphonium chloride, tetraphenylphosphonium chloride.

As described above, the method of synthesizing organochlorosilanes containing two trichlorosilyl groups according to this patent requires only catalytic amount of quaternary phosphonium salt and the catalyst can be easily separated from the product mixture and recycled. These double silylation reactions are new and also useful for the synthesis of a wide range of functional organosilicon compounds with good yields.

The invention will be further illustrated by the following examples. However, they should not be construed as limiting the scope of this invention defined by the appended claims.

### EXAMPLE 1

### Reaction of 1-hexene with trichlorosilane

In a 25 ml oven dried stainless steel tube, 0.35 g (1.19 mmol) of tetrabutylphosphonium chloride, 1.00 g (11.88 mmol) of 1-hexene, and 6.44 g (47.52 mmol) of trichlorosilane were added under a dry nitrogen atmosphere. After sealing the cylinder with a cap, the reactor was maintained at 180° C. for 12 hrs. The resulting mixture was distilled under vacuum to yield 2.67 g of 1,2-bis(trichlorosilyl)hexane (yield; 62%) and 0.83 g of 1-hexyltrichlorosilane (yield; 32%).

1,2-bis(trichlorosilyl)hexane:

¹H-NMR(CDCl₃, ppm) 0.89-0.94(t, 3H, —CH₃), 1.30-1.37(dd, 2H, CH₃CH₂—), 1.43-1.52(m, 2H, CH₃CH₂CH₂—), 1.55-1.64(dd, 1H, —CH₂CHSiCl₃CH₂—), 1.78-1.79(d, 2H, Cl₃SiCH₂CH—), 1.80-1.86(m, 2H, CH₃CH₂CH₂CH₂—); MS(70 eV EI) m/z(relative intensity) 219(35, —SiCl₃), 217(32), 179(35), 177(98), 175(100), 135(36), 133(36), 55(18).

1-hexyltrichlorosilane:

¹H-NMR(CDCl₃, ppm) 0.87-0.91(t, 3H, —CH₃), 2.27-1.42(m, 8H, —SiCH₂(CH₂)₄CH₃), 1.53-1.60(m, 2H, Cl₃SiCH₂—); MS(70 eV EI) m/z(relative intensity) 218(3), 189(11), 175(9), 161(13), 133(35 (SiCl₃)+), 57(100), 55(14).

### EXAMPLE 2

### Reaction of 1-hexene with trichlorosilane

In the same apparatus and procedure as Example 1 above, 0.46 g of (1.18 mmol) of benzyltriphenylphosphonium chloride, 1.00 g (11.88 mmol) of 1-hexene, and 6.44 g (47.52 mmol) of trichlorosilane were reacted at 180° C. for 18 hrs. The resulting mixture was distilled under vacuum to yield 2.11 g of 1,2-bis(trichlorosilyl)hexane (yield; 49%) and 1.02 g of 1-hexyltrichlorosilane (yield; 39%).

### EXAMPLE 3

### Reaction of 1-hexene with trichlorosilane

In the same apparatus and procedure as Example 1 above, 0.39 g of (1.19 mmol) of benzyltributylphosphonium chloride, 1.00 g (11.88 mmol) of 1-hexene, and 6.44 g (47.52 mmol) of trichlorosilane were reacted at 180° C. for 15 hrs. The resulting mixture was distilled under vacuum to yield 2.43 g of 1,2-bis(trichlorosilyl)hexane (yield; 58%) and 0.97 g of 1-hexyltrichlorosilane (yield; 37%).

### EXAMPLE 4

### Reaction of 1-hexene with trichlorosilane

In the same apparatus and procedure as Example 1 above, 0.22 g of (1.19 mmol) of tetraethylphosphonium chloride, 1.00 g (11.88 mmol) of 1-hexene, and 6.44 g (47.52 mmol) of trichlorosilane were reacted at 180° C. for 12 hrs. The resulting mixture was distilled under vacuum to yield 2.58 g of 1,2-bis(trichlorosilyl)hexane (yield; 60%) and 0.77 g of 1-hexyltrichlorosilane (yield; 30%).

### EXAMPLE 5

### Reaction of styrene with trichlorosilane

In the same apparatus and procedure as Example 1 above, 0.28 g of (0.96 mmol) of tetrabutylphosphonium chloride, 1.00 g (9.60 mmol) of styrene, and 5.20 g (38.40 mmol) of trichlorosilane were reacted at 180° C. for 2 hrs. The resulting mixture was distilled under vacuum to yield 2.74 g of 1,2-bis(trichlorosilyl)ethylbenxene (yield; 75%) and 0.25 g of phenylethyltrichlorosilane (yield; 11%).

1,2-bis(trichlorosilyl)ethylbenxene:

¹H-NMR(CDCl₃, ppm) 2.11(dd, 2J=15.5 Hz, 3J=2.8 Hz, 1H, SiCHH′), 2.22(dd, 2J=15.5 Hz, 3J=12.6 Hz, 1H, PhCH), 3.13(dd, 2J=12.4 Hz, 3J=2.8, 1H, SiCHH′), 7.29-7.40(m, 5H, Ph);

MS(70 eV EI) m/z(relative intensity); 372(11, M+2), 370(5), 241(35), 239(98), 237(100), 201(17), 165(11), 135(34), 133(34), 104(20), 103(26), 77(17).

phenylethyltrichlorosilane:

MS(70 eV EI) m/z(relative intensity) 240(8, M+2), 238(8), 135(5), 135(5), 105(21), 92(8), 91(100), 78(10), 77(9).

### EXAMPLE 6

### Reaction of styrene with trichlorosilane

In the same apparatus and procedure as Example 1 above, 0.36 g of (0.96 mmol) of tetraphenylphosphonium chloride, 1.00 g (9.60 mmol) of styrene, and 5.20 g (38.40 mmol) of trichlorosilane were reacted at 180° C. for 2 hrs. The resulting mixture was distilled under vacuum to yield 2.22 g of 1,2-bis(trichlorosilyl)ethylbenxene (yield; 61%) and 0.32 g of phenylethyltrichlorosilane (yield; 14%).

### EXAMPLE 7

### Reaction of styrene with trichlorosilane

In the same apparatus and procedure as Example 1 above, 0.37 g of (0.96 mmol) of tetrabutylphosphonium iodide, 1.00 g (9.60 mmol) of styrene, and 5.20 g (38.40 mmol) of trichlorosilane were reacted at 180° C. for 2 hrs. The resulting mixture was distilled under vacuum to yield 2.70 g of 1,2-bis(trichlorosilyl)ethylbenxene (yield; 74%) and 0.32 g of phenylethyltrichlorosilane (yield; 14%).

### EXAMPLE 8

### Reaction of styrene with trichlorosilane

In the same apparatus and procedure as Example 1 above, 0.37 g of (0.96 mmol) of benzyltributylphosphonium chloride, 1.00 g (9.60 mmol) of styrene, and 5.20 g (38.40 mmol) of trichlorosilane were reacted at 180° C. for 2 hrs. The resulting mixture was distilled under vacuum to yield 2.69 g of 1,2-bis(trichlorosilyl)ethylbenxene (yield; 74%) and 0.28 g of phenylethyltrichlorosilane (yield; 12%).

### EXAMPLE 9

### Reaction of styrene with trichlorosilane

In the same apparatus and procedure as Example 1 above, 0.32 g of (0.97 mmol) of 1,2-bis(triphenylphosphonium bromide)ethane, 1.00 g (9.60 mmol) of styrene, and 5.20 g (38.40 mmol) of trichlorosilane were reacted at 180° C. for 2 hrs. The resulting mixture was distilled under vacuum to yield 1.45 g of 1,2-bis(trichlorosilyl)ethylbenxene (yield; 40%) and 0.43 g of phenylethyltrichlorosilane (yield; 19%).

### EXAMPLE 10

### Reaction of styrene with trichlorosilane

In the same apparatus and procedure as Example 1 above, 0.37 g of (0.96 mmol) of benzyltriphenylphosphonium chloride, 1.00 g (9.60 mmol) of styrene, and 5.20 g (38.40 mmol) of trichlorosilane were reacted at 180° C. for 4 hrs. The resulting mixture was distilled under vacuum to yield 2.55 g of 1,2-bis(trichlorosilyl)ethylbenxene (yield; 70%) and 0.50 g of phenylethyltrichlorosilane (yield; 22%).

### EXAMPLE 11

### Reaction of 4-methylstyrene with trichlorosilane

In the same apparatus and procedure as Example 1 above, 0.28 g of (0.96 mmol) of tetrabutylphosphonium chloride, 1.00 g (8.46 mmol) of 4-methylstyrene, and 4.58 g (33.85 mmol) of trichlorosilane were reacted at 180° C. for 2 hrs. The resulting mixture was distilled under vacuum to yield 2.20 g of 1,2-bis(trichlorosilyl)-1-(4-methylphenyl)ethane (yield; 67%) and 0.34 g of (4-methylphenyl)ethyltrichlorosilane (yield; 16%).

1,2-bis(trichlorosilyl)ethyl-4-methylbenzene:

¹H-NMR(CDCl₃, ppm) 2.09(dd, 2J=15.5 Hz, 3J=2.8 Hz, 1H, SiCHH), 2.20(dd, 2J=15.5 Hz, 3J=12.6 Hz, 1H, SiCHH), 2.35(s, 3H, CH₃—Ph), 3.08(dd, 3J=2.8, 12.4 Hz, 1H, PhCH), 7.16(s, 4H, Ph); MS(70 eV EI) m/z(relative intensity) 384(5, M+), 253(99), 251(100), 135(21), 117(47), 115(22), 91(18), 77(5).

(4-methylphenyl)ethyltrichlorosilane:

¹H-NMR(CDCl₃, ppm) 1.74(t, 2H, Cl₃SiCH₂—), 2.34(s, 3H, CH₃—Ph), 2.87(t, 2H, PhCH₂—), 7.13(s, 4H, Ph); MS(70 eV EI) m/z(relative intensity) 254(10, M+2), 252(10), 135(4), 133(4), 119(6), 117(6), 106(10), 105(100), 77(7).

### EXAMPLE 12

### Reaction of 4-methylstyrene with trichlorosilane

In the same apparatus and procedure as Example 1 above, 0.31 g of (0.96 mmol) of benzyltributylphosphonium chloride, 1.00 g (8.46 mmol) of 4-methylstyrene, and 4.58 g (33.85 mmol) of trichlorosilane were reacted at 180° C. for 4 hrs. The resulting mixture was distilled under vacuum to yield 2.13 g of 1,2-bis(trichlorosilyl)-1-(4-methylphenyl)ethane (yield; 65%) and 0.36 g of (4-methylphenyl)ethyltrichlorosilane (yield; 17%).

### EXAMPLE 13

### Reaction of 4-methylstyrene with trichlorosilane

In the same apparatus and procedure as Example 1 above, 0.32 g of (0.96 mmol) of tetrabutylphosphonium chloride, 1.00 g (8.46 mmol) of 4-methylstyrene, and 4.58 g (33.85 mmol) of trichlorosilane were reacted at 180° C. for 4 hrs. The resulting mixture was distilled under vacuum to yield 2.10 g of 1,2-bis(trichlorosilyl)-1-(4-methylphenyl)ethane (yield; 64%) and 0.38 g of (4-methylphenyl)ethyltrichlorosilane (yield; 18%).

### EXAMPLE 14

### Reaction of 4-methylstyrene with trichlorosilane

In the same apparatus and procedure as Example 1 above, 0.16 g of (0.96 mmol) of benzyltributylphosphonium chloride, 1.00 g (8.46 mmol) of 4-methylstyrene, and 4.58 g (33.85 mmol) of trichlorosilane were reacted at 180° C. for 4 hrs. The resulting mixture was distilled under vacuum to yield 2.97 g of 1,2-bis(trichlorosilyl)-1-(4-methylphenyl)ethane (yield; 60%) and 0.47 g of (4-methylphenyl)ethyltrichlorosilane (yield; 22%).

### EXAMPLE 15

### Reaction of allylbenzene with trichlorosilane

In the same apparatus and procedure as Example 1 above, 0.25 g of (0.85 mmol) of tetrabutylphosphonium chloride, 1.00 g (8.46 mmol) of allylbenzene, and 4.58 g (33.85 mmol) of trichlorosilane were reacted at 180° C. for 8 hrs. The resulting mixture was distilled under vacuum to yield 2.09 g of 1,2-bis(trichlorosilyl)propylbenzene (yield; 64%) and 0.38 g of (3-phenylpropyl)trichlorosilane (yield; 18%).

1,2-bis(trichlorosilyl)propylbenzene:

¹H-NMR(CDCl₃, ppm) 1.68(dd, 2J=9.6 Hz, 3J=9.3 Hz, 1H, —CHSiCHH), 1.97(dd, 2J=3.6 Hz, 3J=3.6 Hz, 1H, —CHSiCHH), 2.25(m, 1H, CH₂CHSiCl₃), 3.14(t, 2H, PhCH2), 7.31-7.41(m, 5H, Ph); MS(70 eV EI) m/z(relative intensity) 384(5, M+), 255(26), 253(75), 251(77), 225(26), 223(27), 135(25), 133(25), 117(51), 115(38), 91(100), 77(10).

(3-phenylpropyl)trichlorosilane:

¹H-NMR(CDCl₃, ppm) 1.49(t, 2H, —CH₂CH₂SiCl₃), 2.00(m, 2H, —CH₂CH₂CH₂SiCl₃), 2.80(t, 2H, PhCH₂CH₂—), 7.24-7.42(m, 5H, Ph); MS(70 eV EI) m/z(relative intensity) 254(5, M+2), 252(5), 135(3), 133(3), 91(100), 77(3).

### EXAMPLE 16

### Reaction of allylbenzene with trichlorosilane

In the same apparatus and procedure as Example 1 above, 0.65 g of quaternary phosphonium chloride containing silicone resin [(RSiO_{3/2})ₙ, R={3-(tributylphosponium)propyl}chloride], 1.00 g (8.46 mmol) of allylbenzene, and 4.58 g (33.85 mmol) of trichlorosilane were reacted at 180° C. for 18 hrs. The resulting mixture was distilled under vacuum to yield 1.63 g of 1,2-bis(trichlorosilyl)propylbenzene (yield; 50%) and 0.38 g of (3-phenylpropyl)trichlorosilane (yield; 20%).

### EXAMPLE 17

### Reaction of 4-vinyl-1-cyclohexene with trichlorosilane

In the same apparatus and procedure as Example 1 above, 0.27 g of (0.92 mmol) of tetrabutylphosphonium chloride, 1.00 g (9.24 mmol) of 4-vinyl-1-cyclohexene, and 5.00 g (36.98 mmol) of trichlorosilane were reacted at 180° C. for 12 hrs. The resulting mixture was distilled under vacuum to yield 1.77 g of (3-cyclohexenyl)-1,2-bis(trichlorosilyl)ethane (yield; 51%) and 0.81 g of [2-(3-cyclohexenyl)ethyl]trichlorsilane (yield; 36%).

(3-cyclohexenyl)-1,2-bis(trichlorosilyl)ethane

MS(70 eV EI) m/z(relative intensity) 376(4, M+2), 374(2, M+), 243(65), 241(65), 135(28), 133(28), 81(73), 79(31), 67(43), 54(100).

[2-(3-cyclohexenyl)ethyl]trichlorsilane:

MS(70 eV EI) m/z(relative intensity) 244(6, M+4), 242(6, M+2), 135(10), 133(10) 95(6), 81(100), 79(15), 67(21), 54(34).

### EXAMPLE 18

### Reaction of 1-pentene with trichlorosilane

In the same apparatus and procedure as Example 1 above, 0.42 g of (1.43 mmol) of tetrabutylphosphonium chloride, 1.00 g (14.26 mmol) of 1-pentene, and 7.73 g (57.04 mmol) of trichlorosilane were reacted at 180° C. for 8 hrs. The resulting mixture was distilled under vacuum to yield 3.77 g of (1,2-bis(trichlorsilyl)petane (yield; 78%).

1,2-bis(trichlorsilyl)pentane:

¹H-NMR(CDCl₃, ppm) 0.92-0.97(t, 3H, —CH₃), 1.47-1.54(m, 2H, CH₃CH₂—), 1.56-1.64(dd, 1H, —CH₂CHSiCl₃—), 1.78-1.79(d, 2H, -CH₂SiCl₃); 1.82-1.86(m, 2H, CH₃CH₂CH₂—); MS 70 eV EI) m/z(relative intensity) 336(1, M+), 207(35), 205(100), 203(99), 177(44), 175(45), 135(62), 133(65), 99(10), 69(25), 63(19).

### EXAMPLE 19

### Reaction of trans-stylbene with trichlorosilane

In the same apparatus and procedure as Example 1 above, 0.16 g of (0.55 mmol) of tetrabutylphosphonium chloride, 1.00 g (5.55 mmol) of trans-stylbene dissolved in 5 ml of toluene, and 7.73 g (57.04 mmol) of trichlorosilane were reacted at 180° C. for 8 hrs. The resulting mixture was distilled under vacuum to eliminate low boiling materials and the residue was recrystallized from n-hexane to yield 0.87 g of 1,2-diphenyl-1,2-bis(trichlorosilyl)ethane (yield; 35%).

1,2-diphenyl-1,2-bis(trichlorosilyl)ethane:

¹H-NMR(CDCl₃, ppm) 3.65(s, 1H, Ph—CHSiCl₃—), 7.32-7.47(m, 5H, Ph—); MS (70 eV EI) m/z(relative intensity) 448(15, M+2), 446(7, M+), 317(30), 315(88), 313(87), 225(97), 223(100) 179(88), 135(35), 133(32), 125(24), 89(25), 77(19).

### EXAMPLE 20

### Reaction of cyclopentene with trichlorosilane

In the same apparatus and procedure as Example 1 above, 0.43 g of (1.46 mmol) of tetrabutylphosphonium chloride, 1.00 g (14.68 mmol) of cyclopentene, and 7.95 g (58.72 mmol) of trichlorosilane were reacted at 180° C. for 24 hrs. The resulting mixture was distilled under vacuum to yield 0.99 g of cis-1,2-bis(trichlorosilyl)cyclopentene (yield; 20%), 0.89 g of trans-1,2-bis(trichlorosilyl)cyclopentene (yield; 18%), and 1.11 g of cyclopentyltrichlorsilane (yield; 36%).

cis-1,2-bis(trichlorsilyl)cyclopetane:

¹H-NMR(CDCl₃, ppm) 0.97-0.99(m), 1.81-1.84(m), 2.04-2.09(m, cyclopentyl H).

trans-1,2-bis(trichlorsilyl)cyclopetane:

¹H-NMR(CDCl₃, ppm) 1.81-1.85(m), 1.99-2.04(m), 2.11-2.14(m, cyclopentyl H); MS(70 eV EI) m/z(relative intensity) 203(100, M+2, —SiCl₃), 201(98), 167(37), 165(54), 135(38), 133(38), 67(93), 65(13), 63(16).

cyclopetyltrichlorosilane:

¹H-NMR(CDCl₃, ppm) 1.57-1.77(m, 8H, —CH₂—), 1.92-1.96(m, 1H, Cl₃SiCH—); MS(70 eV EI) m/z(relative intensity) 202(2), 176(11), 174(11), 133(14), 69(100), 68(23), 67(14), 65(4), 63(5).

### EXAMPLE 21

### Reaction of 1,5-hexadiene with trichlorosilane

In the same apparatus and procedure as Example 1 above, 0.36 g of (1.22 mmol) of tetrabutylphosphonium chloride, 1.00 g (12.17 mmol) of 1,5-hexadiene, and 13.20 g (97.45 mmol) of trichlorosilane were reacted at 180° C. for 18 hrs. The resulting mixture was distilled under vacuum to yield 2.27 g of 1,2,5,6-(tetratrichlorosilyl)hexane (yield; 30%).

1,2,5,6-(tetratrichlorosilyl)hexane:

MS(70 eV EI) m/z(relative intensity) 485(25, M+4, —SiCl₃), 483(24, M+2, —SiCl₃), 481 (8, ——SiCl₃), 313(39), 311(81), 309(95), 307(48), 275(15), 273(22), 177(73), 175(73), 175(72), 139(49), 135(99), 133(100).

### EXAMPLE 22

### Reaction of 1-decene with trichlorosilane

In the same apparatus and procedure as Example 1 above, 0.21 g of (0.71 mmol) of tetrabutylphosphonium chloride, 1.00 g (7.13 mmol) of 1-decene, and 3.86 g (28.52 mmol) of trichlorosilane were reacted at 180° C. for 18 hrs. The resulting mixture was distilled under vacuum to yield 2.25 g of 1,2-bis(trichlorosilyl)decane (yield; 77%).

1,2-bis(trichlorosilyl)decane:

MS(70 eV EI) m/z(relative intensity) 275(24, M+2, —SiCl₃), 273(25, —SiCl₃), 219(29), 217(30), 205(27), 203(28), 191(26), 189(27), 177(41), 175(41), 135(39), 99(25), 71(69), 57(100), 55(27).

### EXAMPLE 23

### Reaction of cyclopentadiene with trichlorosilane

In the same apparatus and procedure as Example 1 above, 0.45 g of (1.51 mmol) of tetrabutylphosphonium chloride, 1.00 g (7.13 mmol) of cyclohexadiene, and 16.39 g (121.03 mmol) of trichlorosilane were reacted at 180° C. for 18 hrs. The resulting mixture was distilled under vacuum to yield 1.83 g of 1,2,3,4-tetra(trichlorosilyl)cyclopetane (yield; 20%).

1,2,3,4-tetra(trichlorosilyl)cyclopetane:

MS(70 eV EI) m/z(relative intensity) 467(60, M+4, —SiCl₃), 467(45, M+2, —SiCl₃), 465(16, —SiCl₃), 435(70), 433(100), 431(85), 301(54), 299(89), 297(74), 165(60), 163(89), 135(91), 133(92), 65(22), 63(31).

### EXAMPLE 24

### Reaction of norbonylene with trichlorosilane

In the same apparatus and procedure as Example 1 above, 0.31 g of (1.05 mmol) of tetrabutylphosphonium chloride, 1.00 g (10.62 mmol) of norbonylene, and 8.44 g (62.31 mmol) of trichlorosilane were reacted at 180° C. for 12 hrs. The resulting mixture was distilled under vacuum to yield 1.83 g of 2,3-bis(trichlorosilyl)bicyclo[2,2,1]heptane (yield; 47%) and 0.66 g of bicyclocyclo[2,2,1]-2-heptyltrichlorosilane (yield; 27%). 2,3-bis(trichlorosilyl)bicyclo[2,2,1]heptane: MS(70 eV EI) m/z(relative intensity) 362(1, M+2), 327(2), 297(2), 227(100), 119(7), 163(8), 133(14), 93(12), 67(20).

bicyclocyclo[2,2,1]-2-heptyltrichlorosilane: MS(70 eV EI) m/z(relative intensity) 228(6), 199(18), 187(7), 133(15), 95(100), 67(79), 54(10).

### EXAMPLE 25

### Reaction of 1,4-cyclohexadiene with trichlorosilane

In the same apparatus and procedure as Example 1 above, 0.37 g of (1.25 mmol) of tetrabutylphosphonium chloride, 1.00 g (12.48 mmol) of 1,4-cyclohexadiene, and 5.75 g (42.48 mmol) of trichlorosilane were reacted at 180° C. for 4 hrs. The resulting mixture was distilled under vacuum to yield 3.13 g of 4,5-bis(trichlorosilyl)cyclohexene (yield; 72%) and 0.22 g of trichlorosilyl-3-cyclohexene (yield; 8%).

4,5-bis(trichlorosilyl)cyclohexene: MS(70 eV EI) m/z(relative intensity) 348(8, M+2), 213(100), 177(39), 133(30), 79(59), 63(9), 51(7).

trichlorosilyl-3-cyclohexene: MS(70 eV EI) m/z(relative intensity) 214(7), 177(1), 163(2), 133(6), 81(100), 67(5), 53(10)

### EXAMPLE 26

### Reaction of divinylbenzene with trichlorosilane

In the same apparatus and procedure as Example 1 above, 0.22 g of (0.75 mmol) of tetrabutylphosphonium chloride, 1.00 g (7.68 mmol) of divinylbenzene, and 6.24 g (46.07 mmol) of trichlorosilane were reacted at 180° C. for 4 hrs. The resulting mixture was distilled under vacuum to yield 3.74 g of bis(1,2-bistrichlorosilylethyl)benzene (yield; 73%) and 0.22 g of bis(2-trichlorosilylethyl)benzene (yield; 14%).

bis(1,2-bistrichlorosilylethyl)benzene: MS(70 eV EI) m/z(relative intensity) 668(4, M+4), 533(100), 397(4), 335(5), 263(24), 227(11), 201(26), 165(13), 133(69), 63(12).

bis(2-trichlorosilylethyl)benzene: MS(70 eV EI) m/z(relative intensity) 400(14, M+2), 267(100), 201(6), 133(19), 117(21), 91(13), 77(8), 63(5), 51(2).

### EXAMPLE 27

### Reaction of allyltrichlorosilane with trichlorosilane

In the same apparatus and procedure as Example 1 above, 0.22 g of (0.75 mmol) of tetrabutylphosphonium chloride, 1.00 g (5.69 mmol) of allyltrichlorosilane, and 6.24 g (46.07 mmol) of trichlorosilane were reacted at 180° C. for 4 hrs. The resulting mixture was distilled under vacuum to yield 4.48 g of 1,2,3-tris(trichlorosilyl)propane (yield; 70%).

1,2,3-tris(trichlorosilyl)propane: MS(70 eV EI) m/z(relative intensity) 339(11, M—SiCl₃), 309(100), 273(19), 163(7), 133(45), 63(9).

Having now fully described the present invention, it will be apparent to one of ordinary skill in the art that many changes and modifications can be made thereto without departing from the spirit of scope of the invention as set forth herein.

What is claimed is:

1. Organosilicon compounds containing two trichlorosilyl groups represented by the following formula II, 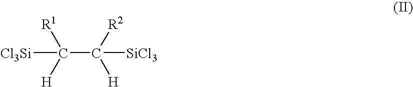
wherein R¹ and R² may be identical or different and represent a linear or a cyclic C₃-C₈ alkyl, a linear or a cyclic C₂-C₈ alkenyl, benzyl, a C₁-C₈ alkyl substituted phenyl group, a trichlorosilyl group substituted C₁-C₈ alkyl, (a trichlorosilyl group substituted C₁-C₈ alkyl)phenyl, two functional groups between R¹ and R² may be covalently bonded to form a C₄-C₈ ring with or without a carbon-carbon double bond.

2. A process for preparing organosilicon compounds represented by the following formula II, comprising a dehydrogenative double silylation reaction of olefins represented by formula I with trichlorosilane in the presence of quaternary organophosphonium salt as a catalyst,
R¹—HC═CH—R² (I) 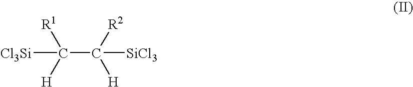
wherein R¹ and R² may be identical or different and represent a hydrogen atom, a linear or a cyclic C₁-C₈ alkyl, a linear or a cyclic C₁-C₈ alkenyl, benzyl, phenyl, a C₁-C₈ alkyl substituted phenyl group, two functional groups between R¹ and R² may be covalently bonded to form a C₄-C₈ ring with or without a carbon-carbon double bond.

3. The process for preparing organosilicon compounds according to claim 2, wherein said amount of trichlorosilane used is 1-8 folds of the amount of olefins of formula I.

4. The process for preparing organosilicon compounds according to claim 2, wherein said catalyst has the following formula III,
X(R⁴)₄P (III)
wherein X is chloro, bromo, iodo; and R⁴ can be covalently bonded to form a C₄-C₈ ring with or without a carbon-carbon double bond and each R⁴ is independently selected from a V₁₋₁₂ alkyl, C₁₋₆ alkyl substituted aromatics or phenyl groups.

5. The process for preparing organosilicon compounds according to claim 2, wherein said catalyst has the following general formula IV,
X(R⁴)₃P—Y—P(R⁴)₃X (IV)
wherein X is chloro, bromo, iodo; Y is selected from a C₁-C₁₂ alkyl or alkenyl and optionally alkyl substituted aromatic; and R⁴ can be covalently bonded to form a C₁-C₁₂ alkyl, a ring with or without a carbon-carbon double bond and each R⁴ is independently selected from a V₁₋₁₂ alkyl, C₁₋₆ alkyl substituted aromatics or phenyl groups.

6. The process for preparing organosilicon compounds according to any one of claims 2, 3, 4, or 5, wherein said catalyst has a quaternary phosphonium group immobilized on a silicone resin, silica, inorganic supporter or organic polymer.

7. The process for preparing organosilicon compounds according to any one of claims 2, 3, 4, or 5, wherein the amount of catalyst used is 1-100% by mole of the compound of formula I.

8. The process for preparing organosilicon compounds according to any one of claims 2, 3, 4, or 5, wherein said reaction is carried out at a temperature from 10° C. to 250° C.

9. The process for preparing organosilicon compounds according to claim 2, wherein said reaction is carried out in a neat condition.

10. The process for preparing organosilicon compounds according to claim 9, wherein said organic solvent is selected from the group consisting of benzene, toluene, hexane, tetrahydrofuran, and acetonitrile.
